(19) United States
(12) Patent Application Publication
(10) Pub. No.: US 2025/0390982 A1
(43) Pub. Date: Dec. 25, 2025

(54) ELECTRONIC DEVICE FOR SELECTING ONE OF PLURALITY OF VISUAL OBJECTS AND METHOD THEREFOR

(71) Applicant: Samsung Electronics Co., Ltd., Suwon-si (KR)

(72) Inventors: Yoonsu KIM, Suwon-si (KR); Hyunjin KIM, Suwon-si (KR); Donghee KANG, Suwon-si (KR)

(21) Appl. No.: 19/312,096

(22) Filed: Aug. 27, 2025

Related U.S. Application Data
(63) Continuation of application No. PCT/KR2024/000663, filed on Jan. 12, 2024.

(30) Foreign Application Priority Data
Feb. 27, 2023 (KR) 10-2023-0026054

(51) Int. Cl. G06T 3/40; G06F 3/0481

(52) U.S. Cl. CPC G06T 3/40; G06F 3/0481

(57) ABSTRACT

While displaying a screen including a plurality of visual objects within a projection area formed by a projection assembly, a processor of an electronic device may identify a first distance between the projection area and a user and a second distance between the user and the electronic device by using a first sensor. On the basis of identifying a body part facing the projection area by using a second sensor, the processor may select an area of the projection area toward which the body part is facing by using a length related to the first distance and the second distance. On the basis of identifying the plurality of visual objects in the selected area, the processor may change the plurality of visual objects on the basis of the length.

### CROSS-REFERENCE TO RELATED APPLICATIONS

This application is a continuation application of International Application No. PCT/KR2024/000663, filed on Jan. 12, 2024, in the Korean Intellectual Property Receiving Office, and claiming priority to Korean Patent Application No. 10-2023-0026054 filed Feb. 27, 2023, the disclosures of which are all hereby incorporated by reference herein in their entireties.

### TECHNICAL FIELD

Certain example embodiments may relate to an electronic device for selecting one of a plurality of visual objects and/or a method thereof.

### BACKGROUND

An electronic device for visualizing information is being developed. The electronic device may include a television, a monitor, an electric board, a beam projector, a mobile phone, and/or a tablet personal computer (PC). The electronic device may form a displaying area representing the information on a surface of the electronic device or an external surface of the electronic device.

### SUMMARY

An electronic device according to an example embodiment may include a first sensor, a second sensor, a projection assembly, and at least one processor comprising processing circuitry. The at least one processor may, individually and/or collectively, identify, while displaying a screen including a plurality of visual objects in a projection area formed by the projection assembly, using the first sensor, a first distance between the projection area and a user, and a second distance between the user and the electronic device. The at least one processor may select, based on identifying a body part toward the projection area using the second sensor, an area of the projection area to which the body part is directed, using a length associated with the first distance and the second distance. The at least one processor may change, based on identifying the plurality of visual objects in the selected area, the plurality of visual objects based on the length.

A method of an electronic device according to an embodiment may include, while displaying a first screen including a plurality of visual objects in a projection area formed by a projection assembly, identifying, using a first sensor, a first distance between the projection area and a user, and a second distance between the user and the electronic device. The method may include, based on identifying a body part toward the projection area using a second sensor, selecting an area of the projection area to which the body part is directed, using a length associated with the first distance and the second distance. The method may include, based on identifying the plurality of visual objects in the selected area, changing the plurality of visual objects based on the length.

In a non-transitory computer readable storage medium storing one or more programs according to an embodiment, the one or more programs, when executed by a processor of an electronic device, may cause the processor of the electronic device to, while displaying a first screen including a plurality of visual objects in a projection area formed by a projection assembly, identify, using a first sensor, a first distance between the projection area and a user, and a second distance between the user and the electronic device. The one or more programs, when executed by the processor of the electronic device, may cause the processor of the electronic device to, based on identifying a body part toward the projection area using a second sensor, select an area of the projection area to which the body part is directed, using a length associated with the first distance and the second distance. The one or more programs, when executed by the processor of the electronic device, may cause the processor of the electronic device to, based on identifying the plurality of visual objects in the selected area, change the plurality of visual objects based on the length.

### BRIEF DESCRIPTION OF THE DRAWINGS

FIG. 1A illustrates an example of a state of use of an electronic device according to an example embodiment.

FIG. 1B illustrates an example of an electronic device that changes visual objects, according to an example embodiment.

FIG. 2 illustrates an example of a block diagram of an electronic device according to an example embodiment.

FIG. 3 illustrates an example of an electronic device that obtains a radius value, according to an example embodiment.

FIG. 4 illustrates an example associated with a radius value based on distances, according to an example embodiment.

FIG. 5A illustrates an example of an electronic device that identifies a visual object within a range, according to an example embodiment.

FIG. 5B illustrates an example of an electronic device that changes visual objects, according to an example embodiment.

FIG. 5C illustrates an example of an electronic device that changes visual objects, according to an example embodiment.

FIG. 6 illustrates an example of an electronic device that adjusts a size of a screen, according to an example embodiment.

FIG. 7 illustrates an example of an electronic device that changes visual objects, according to an example embodiment.

FIG. 8 illustrates an example of an electronic device that changes visual objects, according to an example embodiment.

FIG. 9 illustrates an example of an electronic device that changes visual objects, according to an example embodiment.

FIG. 10 illustrates an example of a flowchart of an operation of an electronic device according to an example embodiment.

FIG. 11 is an exemplary diagram of an example network environment in which a metaverse service is provided through a server.

### DETAILED DESCRIPTION

Hereinafter, various embodiments of the present document will be described with reference to the accompanying drawings.

The various embodiments of the present document and terms used herein are not intended to limit the technology described in the present document to specific embodiments, and should be understood to include various modifications, equivalents, or substitutes of the corresponding embodiment. In relation to the description of the drawings, a reference numeral may be used for a similar component. A singular expression may include a plural expression unless it is clearly meant differently in the context. In the present document, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, are only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component(s) (e.g., a third component). Thus, for example, “connected” as used herein covers both direct and indirect connections.

The term “module” used in the present document may include a unit configured with hardware, software, or firmware, and may be used interchangeably with terms such as logic, logic block, component, or circuit, and the like. The module may be an integrally configured component or a minimum unit or part thereof that performs one or more functions. For example, a module may be configured with an application-specific integrated circuit (ASIC). Thus, each “module” herein may comprise circuitry.

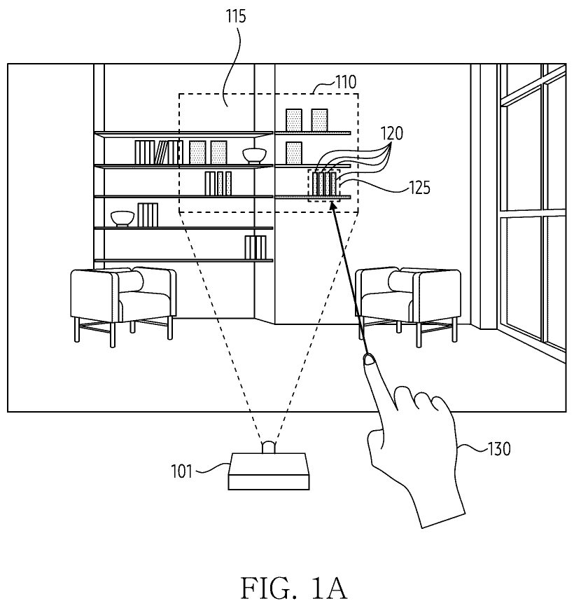

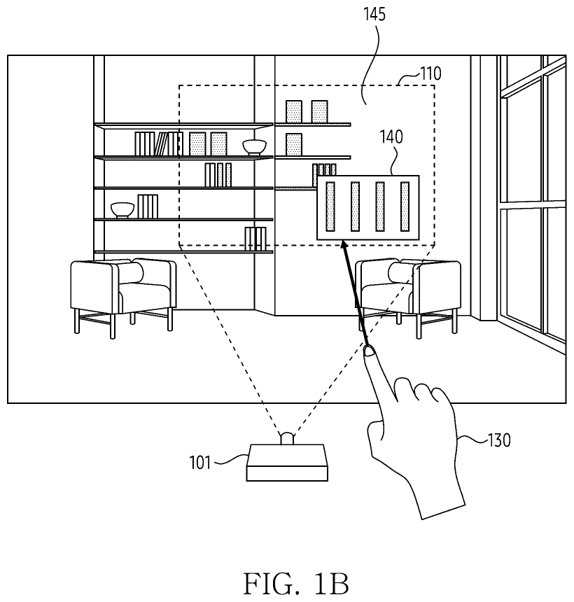

FIG. 1A illustrates an example of a state of use of an electronic device according to an embodiment. FIG. 1B illustrates an example of an electronic device that changes visual objects, according to an embodiment. Referring to FIG. 1A, an electronic device 101 according to an embodiment may include an electronic device for projecting light such as a beam projector. For example, the beam projector may include a liquid crystal display (LCD) projector, a cathode-ray tube (CRT) projector, a digital light processing (DLP) projector, and/or a light emitting diode (LED) projector. The electronic device 101 may output the light representing a screen formed by pixels arranged two-dimensionally. The light outputted from the electronic device 101 may be reflected by an object such as a plane. A user may view the screen based on the light reflected by the object. The electronic device 101 may project a screen obtained from an interface. The interface may include a hardware interface and/or a software interface. For example, the hardware interface may include a component for establishing a communication link with an external electronic device (e.g., a personal computer (PC) such as a laptop and a desktop, a smartphone, a smartpad, a tablet PC, and a smart accessory such as a smartwatch). For example, the software interface may include a software application and/or a program that may be executed by the electronic device 101.

Referring to FIGS. 1A and 1B, the electronic device 101 according to an embodiment may form a projection area 110 using a projection assembly. The electronic device 101 may project a first screen 115 into the projection area 110. The electronic device 101 may project the first screen 115 including a plurality of visual objects 120. For example, the plurality of visual objects 120 may be the visual objects 120 associated with media content and/or multimedia content. The electronic device 101 may identify a point indicated by a user 130 while projecting the first screen 115 including the plurality of visual objects 120. For example, the point indicated by the user 130 may be a point extending from an eye toward a fingertip. For example, the point indicated by the user 130 may include a point pointed for an input in the first screen 115. For example, the point indicated by the user 130 may be a point extending from a part (e.g., the fingertip) of a body of the user 130. For example, the point indicated by the user 130 may be a point corresponding to an input of the user 130 based on the external electronic device such as a controller. For example, the point indicated by the user 130 may be a point corresponding to an input of the user 130 based on an external object. The point indicated by the user 130 may be represented as a coordinate value. The point indicated by the user 130 may be an area including the coordinate value. However, it is not limited thereto.

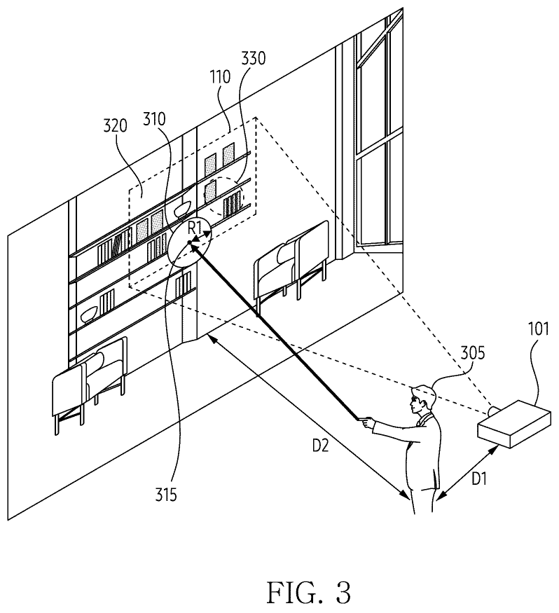

The electronic device 101 according to an embodiment may identify a first distance between the projection area 110 and the user 130 using a first sensor while displaying the first screen 115 including the plurality of visual objects 120. The electronic device 101 may identify a second distance between the user 130 and the electronic device 101 while displaying the first screen 115. For example, the first sensor may include a depth sensor and/or an infrared sensor. For example, the depth sensor may include a time-of-flight (ToF) sensor, structured light, and a light detection and ranging (LiDAR). The electronic device 101 may identify the first distance and/or the second distance using the first sensor. The electronic device 101 may obtain a length associated with the first distance and the second distance based on the first distance and the second distance. For example, the length may be a value for forming a range including the point. A description of the length will be described later in FIGS. 3 and/or 4.

The electronic device 101 according to an embodiment may identify a body part toward a projection area using a second sensor. The body part may mean the finger of the user. For example, the second sensor may include an image sensor. The electronic device 101 may select an area of the projection area to which the body part is directed, by using the length associated with the first distance and the second distance, based on identifying the body part toward the projection area using the second sensor. For example, the area may be a range formed by a set of dots spaced apart by the length from a point selected by the body part.

The electronic device 101 according to an embodiment may identify a range including the point indicated by the user 130 based on a radius value obtained based on the first distance and the second distance. The electronic device 101 may identify the plurality of visual objects 120 included within the range. The electronic device 101 may change a partial area 125 including the plurality of visual objects 120 based on identifying the plurality of visual objects 120. For example, the electronic device 101 may change the plurality of visual objects 120. The electronic device 101 may enlarge the partial area 125 including the plurality of visual objects 120. The electronic device 101 may change the plurality of visual objects 120. For example, the electronic device 101 may change a disposition of the plurality of visual objects 120. For example, the electronic device 101 may enlarge the plurality of visual objects 120. The electronic device 101 may display a second screen 145 in which the plurality of visual objects 120 are changed. For example, the electronic device 101 may display a partial area 140 in which the plurality of visual objects 120 are changed on the second screen 145. The electronic device 101 may display the second screen 145 in which the plurality of visual objects 120 are changed in the partial arca 140.

As described above, the electronic device 101 according to an embodiment may identify the point indicated by the user 130. The electronic device 101 may identify the plurality of visual objects 120 in a reference distance (e.g., a distance corresponding to a radius value) from the point indicated by the user 130. The electronic device 101 may change the plurality of visual objects 120 based on identifying the plurality of visual objects 120 in the reference distance from the point. The electronic device 101 may display the second screen 145 in which the plurality of visual objects 120 are changed. By displaying the second screen 145, the electronic device 101 may induce an accurate selection when the user of the electronic device 101 selects one of the plurality of visual objects 120.

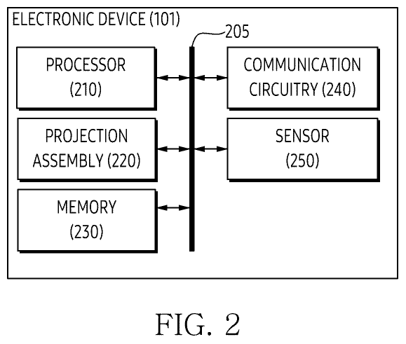

FIG. 2 illustrates an example of a block diagram of an electronic device according to an embodiment. An electronic device 101 of FIG. 2 may include the electronic device 101 of FIGS. 1A and/or 1B.

Referring to FIG. 2, the electronic device 101 according to an embodiment may include at least one of a processor 210, a projection assembly 220, memory 230, communication circuitry 240, or a sensor 250. The processor 210, the projection assembly 220, the memory 230, the communication circuitry 240, and the sensor 250 may be electrically and/or operably coupled, directly or indirectly, with each other by a communication bus 205. Hereinafter, hardware operably being coupled with each other may mean that a direct connection or an indirect connection between the hardware is established by wire or wirelessly so that second hardware is controlled by first hardware among the hardware. Even though illustrated in different blocks, an embodiment is not limited thereto. Some (e.g., at least a portion of the processor 210, the memory 230, and the communication circuitry 240) of the hardware of FIG. 2 may be included in a single integrated circuit such as a system on a chip (SoC). A type and/or the number of the hardware included in the electronic device 101 is not limited as illustrated in FIG. 2. For example, the electronic device 101 may include only some of the hardware illustrated in FIG. 2.

The electronic device 101 according to an embodiment may include hardware for processing data based on one or more instructions. For example, the hardware for processing the data based on the one or more instructions may include the processor 210. The hardware for processing the data may include, for example, an arithmetic and logic unit (ALU), a floating point unit (FPU), a field programmable gate array (FPGA), a central processing unit (CPU), and/or an application processor (AP). The processor 210 may have a structure of a single-core processor, or may have a structure of a multi-core processor such as a dual core, a quad core, a hexa core, and an octa core. The following operations may be performed by the processor 210.

The projection assembly 220 of the electronic device 101 according to an embodiment may include a plurality of hardware assembled to emit light representing pixels arranged two-dimensionally. For example, the projection assembly 220 may include a combination of cathode-ray tubes (CRTs) for emitting light of each of three primary colors in a color space and lenses for enlarging the light emitted from each of the CRTs. For example, the projection assembly 220 may include a combination of a light source (e.g., a lamp) for emitting light, optical filters for dividing the light into light paths corresponding to each of the three primary colors, liquid crystal display (LCD) panels disposed in each of the light paths, and a prism and/or a lens for synthesizing light outputted from the LCD panels. For example, the projection assembly 220 may include a combination of the light source for emitting the light, an optical filter that selects any one of the three primary colors from the light, a digital mirror device (DMD) to adjust a reflection to a primary color filtered by the optical filter, and the lens to enlarge the light reflected by the DMD. In terms of requiring projection of light for a display of a screen, at least one of the illustrated combinations may be referred to as the projection assembly 220. The electronic device 101 including the projection assembly 220 according to an embodiment may be referred to as a beam projector.

The memory 230 of the electronic device 101 according to an embodiment may include a component for storing data and/or instructions inputted to and/or outputted from the processor 210 of the electronic device 101. For example, the memory 230 may include volatile memory such as random-access memory (RAM) and/or non-volatile memory such as read-only memory (ROM).

For example, the volatile memory may include at least one of dynamic RAM (DRAM), static RAM (SRAM), Cache RAM, and pseudo SRAM (PSRAM). For example, the non-volatile memory may include at least one of programmable ROM (PROM), erasable PROM (EPROM), electrically erasable PROM (EEPROM), flash memory, a hard disk, a compact disk, a solid state drive (SSD), and an embedded multi-media card (cMMC).

The communication circuitry 240 of the electronic device 101 according to an embodiment may include a hardware component for supporting transmission and/or reception of an electrical signal between the electronic device 101 and an external electronic device (e.g., a server and a controller). For example, the communication circuitry 240 may include at least one of a modem (MODEM), an antenna, and an optic/electronic (O/E) converter. The communication circuitry 240 may support the transmission and/or the reception of the electrical signal based on various types of protocols such as Ethernet, a local area network (LAN), a wide area network (WAN), a wireless fidelity (WiFi), Bluetooth, Bluetooth low energy (BLE), ZigBee, a long term evolution (LTE), and a 5th generation new radio (5G NR).

The sensor 250 of the electronic device 101 according to an embodiment may include a depth sensor. For example, the depth sensor may include a time-of-flight (ToF) sensor, structured light, and a light detection and ranging (LiDAR). For example, the electronic device 101 may identify a distance based on light emitted from the sensor 250. For example, the light may include light in an infrared band. For example, the electronic device 101 may identify a first distance between the electronic device 101 and a projection area (e.g., the projection area 110 of FIG. 1A) using the sensor 250. For example, the electronic device 101 may identify a second distance between the electronic device 101 and a user (e.g., the user 130 of FIG. 1A) using the sensor 250. The electronic device 101 may obtain the first distance and the second distance using the sensor 250. The electronic device 101 may change a plurality of visual objects (e.g., the visual objects 120 of FIG. 1A) based on the first distance and the second distance. For example, the electronic device 101 may obtain a radius value based on the first distance and the second distance. An operation of obtaining the radius value will be described later in FIG. 3. The electronic device 101 may change a plurality of visual objects 120 identified within a range formed based on the radius value.

The electronic device 101 according to an embodiment may form the projection arca using the projection assembly 220. The electronic device 101 may display a first screen including the plurality of visual objects in the projection area. For example, the plurality of visual objects may be associated with media content provided by the electronic device 101. The electronic device 101 may identify the first distance between the projection area and the user using the sensor 250 while displaying the first screen. The electronic device 101 may identify the second distance between the user and the electronic device 101 using the sensor 250 while displaying the first screen. The electronic device 101 may obtain the radius value based on the first distance and the second distance. Based on obtaining the radius value, the electronic device 101 may identify a range formed by dots spaced apart from a point indicated by the user by a distance corresponding to the radius value. The electronic device 101 may identify the plurality of visual objects within the range formed around the point. The electronic device 101 may display a second screen in which the identified plurality of visual objects are changed based on identifying the plurality of visual objects. For example, the change may be an operation of enlarging the plurality of visual objects. For example, the change may be an operation of changing an arrangement of the plurality of visual objects. For example, the change may be an operation of rearranging the plurality of visual objects.

The electronic device 101 according to an embodiment may identify the plurality of visual objects within a range including the point indicated by the user. The electronic device 101 may display information associated with the visual objects based on identifying the plurality of visual objects. For example, the information associated with the visual objects may include a title of media content and/or multimedia content corresponding to the visual objects. The electronic device 101 may display the information associated with the visual objects overlapping with the visual objects. For example, the electronic device 101 may display the information in a form of text and/or an image, overlapping with the visual objects. The electronic device 101 may receive the information from the external electronic device through the communication circuitry 240. For example, the external electronic device may be the server. The electronic device 101 may represent the information in the form of text and/or the image based on receiving the information from the external electronic device. For example, the electronic device 101 may load the information stored in the memory 230. The electronic device 101 may represent the information stored in the memory 230 in the form of text and/or the image. For example, the electronic device 101 may represent the information in a form such as a cover of the media content and/or the multimedia content.

As described above, the electronic device 101 according to an embodiment may display the first screen including the plurality of visual objects. The electronic device 101 may identify the point indicated by the user while displaying the first screen. The electronic device 101 may identify a range formed by dots spaced apart from the point by a reference distance. The electronic device 101 may change the plurality of visual objects identified within the range. For example, the electronic device 101 may enlarge the plurality of visual objects identified within the range. For example, the electronic device 101 may rearrange the plurality of identified visual objects identified within the range. The electronic device 101 may help the user of the electronic device 101 accurately select one of the plurality of visual objects by changing the plurality of visual objects identified within the range.

FIG. 3 illustrates an example of an electronic device that obtains a radius value, according to an embodiment. An electronic device 101 of FIG. 3 may include the electronic device 101 of FIGS. 1A, 1B, and/or 2. Operations of FIG. 3 may be performed by the processor 210 of FIG. 2.

Referring to FIG. 3, the electronic device 101 according to an embodiment may form a projection arca 110 using a projection assembly (e.g., the projection assembly 220 of FIG. 2). The electronic device 101 may display a first screen 320 including a plurality of visual objects 330 in the projection area 110. The electronic device 101 may identify an input of a user 305 while displaying the first screen 320. For example, the input of the user 305 may be one point 315 pointed by a body part (e.g., a finger) of the user 305. For example, the input of the user 305 may be the one point 315 indicated by an external electronic device (e.g., a controller). However, it is not limited thereto.

The electronic device 101 according to an embodiment may form an arca 310 around the one point 315. For example, the area 310 may be formed in a circular shape. For example, the electronic device 101 may form the area 310 formed by dots spaced apart by a length R1 around the one point 315. For example, the length R1 may be referred to as the radius value. Hereinafter, an operation of the electronic device 101 for obtaining the radius value is described.

The electronic device 101 according to an embodiment may identify a first distance D1 between the electronic device 101 and the user 305. The electronic device 101 may identify a second distance D2 between a projection area 310 and the user 305. For example, the electronic device 101 may identify the first distance D1 and the second distance D2 using a first sensor (e.g., a depth sensor, a ToF sensor, and/or a LiDAR). The electronic device 101 may identify the body part of the user 305 toward the projection area 310 using a second sensor different from the first sensor. For example, the second sensor may include an image sensor. The body part of the user 305 may include a fingertip of the user. The electronic device 101 may identify the length R1 associated with the first distance D1 and the second distance D2 based on identifying the body part of the user 305. The electronic device 101 may select an area 310 of the projection area 110 to which the body part is directed, using the length R1. For example, the area 310 may be the area 310 formed by the length RI around a point to which the body part of the user 305 is directed.

$$R 1 = ( C 1 * D 1 ) * D 2 * C 2 \qquad [ Equation 1 ]$$

Referring to Equation 1, the electronic device 101 may obtain the length R1 based on the first distance D1 between the electronic device 101 and the user 305, a first constant C1, the second distance D2 between the user 305 and the projection area 110, and a second constant C2. For example, the first constant C1 may be associated with a sensor (e.g., the first sensor and/or the second sensor) included in the electronic device 101. For example, the first constant C1 may have a smaller value as a resolution of the sensor included in the electronic device 101 increases. For example, the first constant C1 may be inversely proportional to the resolution of the sensor included in the electronic device 101. For example, the second constant C2 may be a cognitive deviation constant of an algorithm of the electronic device 101 that identifies the body part of the user 305. For example, the cognitive deviation constant is a constant included in the algorithm and may be a constant set by the electronic device 101. For example, the second constant C2 may provide the user 305 with a guide for obtaining the second constant C2. For example, the guide may be associated with an operation for repeatedly confirming selection by the body part of the user 305. For example, the electronic device 101 may obtain the second constant C2 based on repeatedly identifying the selection by the body part of the user 305 based on the guide. Equation 1 for obtaining the length R1 is not limited to those described above.

The electronic device 101 according to an embodiment may identify a plurality of visual objects in the area 310. The electronic device 101 may change the plurality of visual objects based on the length RI based on identifying the plurality of visual objects in the area 310. For example, the electronic device 101 may enlarge the plurality of visual objects to a size corresponding to at least twice the length R1. For example, the electronic device 101 may increase a distance (or an interval) between the plurality of visual objects to the length R1. For example, the electronic device 101 may arrange the plurality of visual objects identified in the area 310 spaced apart from each other by the length R1. For example, the electronic device 101 may arrange the plurality of visual objects spaced apart from each other by the length R1 and enlarge the plurality of visual objects to the size of the length R1 (or twice the length R1).

As described above, the electronic device 101 according to an embodiment may identify the first distance D1 between the electronic device 101 and the user 305. The electronic device 101 may identify the second distance D2 between the user 305 and the projection area 310. The electronic device 101 may identify the length R1 based on the first distance D1 and the second distance D2. The electronic device 101 may select the area 310 of the projection area 110 to which the body part of the user 305 is directed, using the length R1. The area 310 may be identified based on the one point 315 indicated by the user 305 and the length R1. The electronic device 101 may identify the plurality of visual objects in the selected area 310. The electronic device 101 may change the plurality of visual objects based on the length R1 based on identifying the plurality of visual objects in the area 310. The electronic device 101 may enlarge the plurality of visual objects to the size corresponding to the length R1. The electronic device 101 may arrange the plurality of visual objects spaced apart from each other by the length R1. The electronic device 101 may accurately identify the input of the user 305 selecting the plurality of visual objects by changing the plurality of visual objects as described above. The electronic device 101 may provide a user interface for the user of the electronic device 101 to clearly distinguish and select the plurality of visual objects by changing the plurality of visual objects as described above.

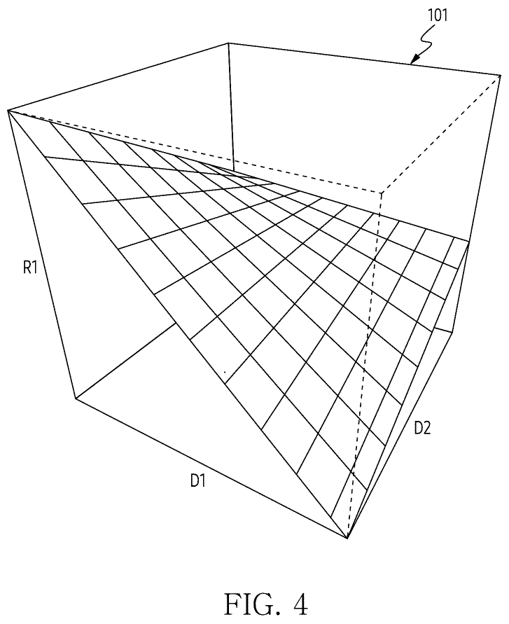

FIG. 4 illustrates an example associated with a radius value based on distances, according to an embodiment. An electronic device 101 of FIG. 4 may include the electronic device 101 of FIGS. 1A, 1B, 2, and/or 3. Operations of FIG. 4 may be performed by the processor 210 of FIG. 2.

Referring to FIG. 4, the electronic device 101 according to an embodiment may obtain a length R1 based on a first distance D1 and a second distance D2. The first distance D1 may be a distance between the electronic device 101 and a user (e.g., the user 305 of FIG. 3). The second distance D2 may be a distance between the user and a projection area (e.g., the projection area 110 of FIG. 3). The electronic device 101 may obtain the length R1 based on the first distance D1 and the second distance D2.

The electronic device 101 according to an embodiment may repeatedly identify the first distance D1 and the second distance D2. The electronic device 101 may obtain an average value of the first distance D1 and the second distance D2 based on identifying the first distance D1 and the second distance D2 more than a preset number of times. The electronic device 101 may obtain the length R1 based on the average value of each of the first distance D1 and the second distance D2. The electronic device 101 according to an embodiment may identify a maximum or large value of each of the first distance D1 and the second distance D2 based on identifying the first distance D1 and the second distance D2 the preset number of times. The electronic device 101 may obtain the length R1 based on the maximum or a large value of each of the first distance D1 and the second distance D2. The electronic device 101 according to an embodiment may perform an algorithm such as interpolation and/or extrapolation with respect to the first distance D1 and the second distance D2. The electronic device 101 may obtain the length R1 based on performing the algorithm such as the interpolation and/or the extrapolation with respect to the first distance D1 and the second distance D2. FIG. 4 may be an example of obtaining the length R1 based on performing the algorithm such as the interpolation and/or the extrapolation with respect to the first distance D1 and the second distance D2.

As described above, the electronic device 101 according to an embodiment may obtain the length R1 by performing the algorithm with respect to the first distance D1 and the second distance D2. The electronic device 101 may select an area (e.g., the area 310 of FIG. 3) to which the body part of the user is directed based on the length R1. The electronic device 101 may identify a plurality of visual objects in the area. The electronic device 101 may change the plurality of visual objects based on identifying the plurality of visual objects in the area. The electronic device 101 may provide the user of the electronic device 101 with a user interface for easily selecting one of the plurality of visual objects by changing the plurality of visual objects based on the length R1.

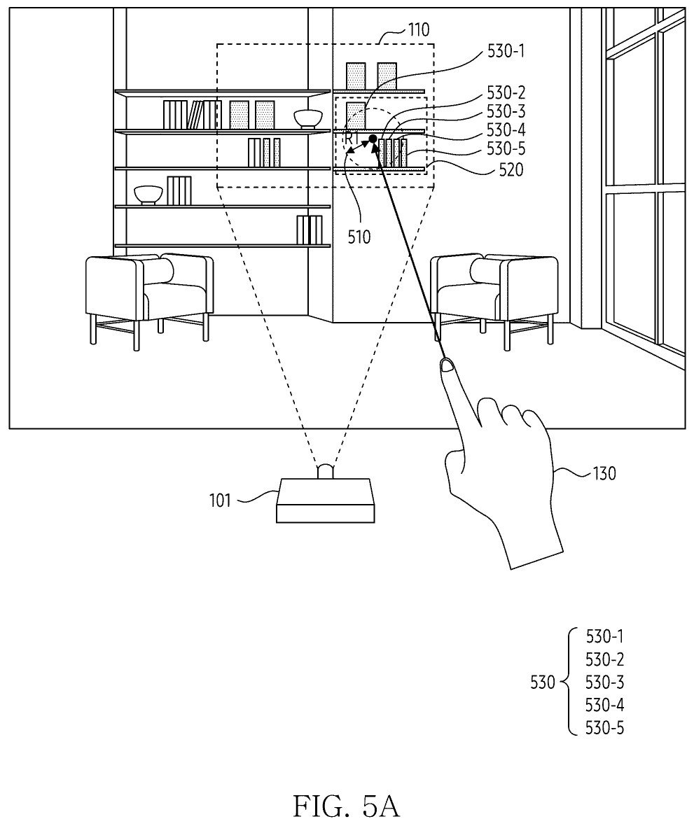

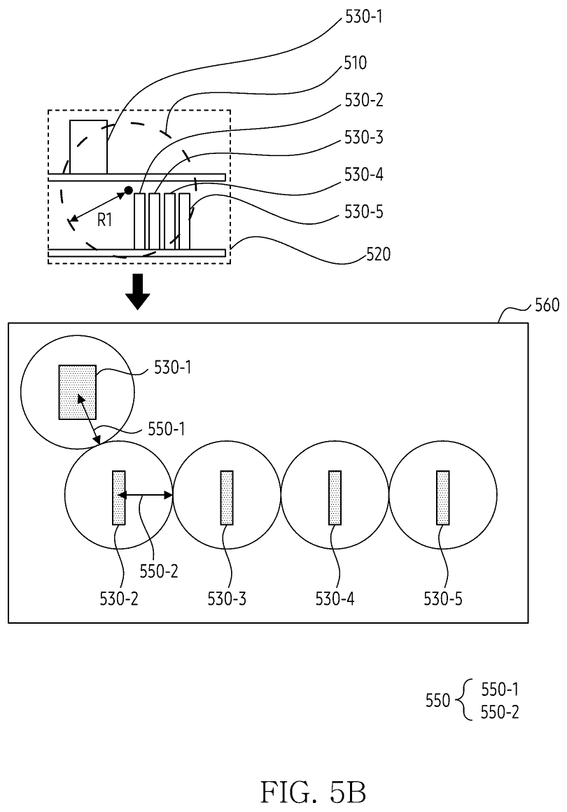

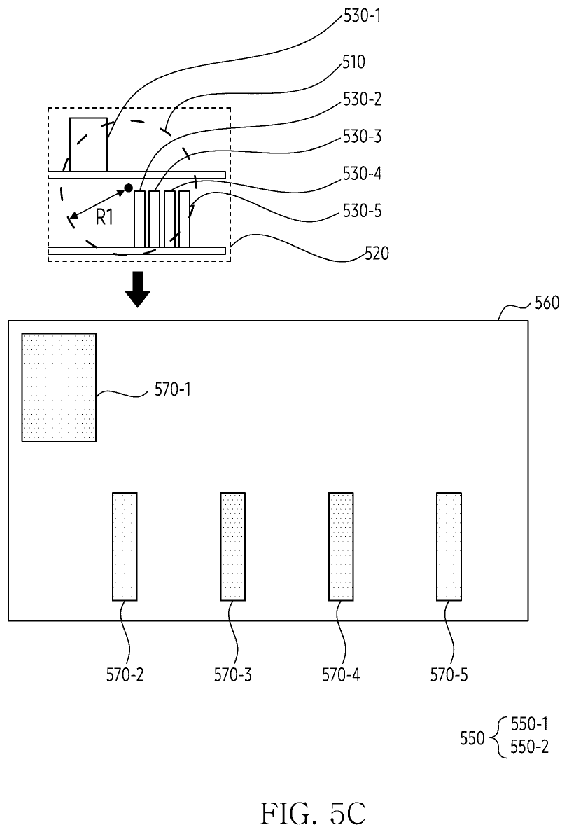

FIG. 5A illustrates an example of an electronic device that identifies a visual object within a range, according to an embodiment. FIG. 5B illustrates an example of an electronic device that changes visual objects, according to an embodiment. FIG. 5C illustrates an example of an electronic device that changes visual objects, according to an embodiment. FIGS. 5A, 5B, and 5C may include the electronic device 101 of FIGS. 1A, 1B, 2, 3, and/or 4. Operations of FIGS. 5A, 5B, and 5C may be performed by the processor 210 of FIG. 2.

Referring to FIG. 5A, an electronic device 101 according to an embodiment may display a first screen including a plurality of visual objects 530 in a projection area 110 formed by a projection assembly (e.g., the projection assembly 220 of FIG. 2). The electronic device 101 may identify a first distance (e.g., the second distance D2 of FIG. 3) between the projection area 110 and a user 130 and a second distance (e.g., the first distance D1 of FIG. 3) between the user 130 and the electronic device 101 by using a first sensor (e.g., a depth sensor) while displaying the first screen. The electronic device 101 may identify a body part (e.g., a finger of a user) toward the projection area 110 using a second sensor different from the first sensor. For example, the second sensor may include an image sensor. The electronic device 101 may obtain a length R1 associated with the first distance and the second distance based on identifying the body part toward the projection area 110 using the second sensor. For example, the length R1 may be referred to as the length R1 of FIG. 3. The electronic device 101 may select a first portion 520 of the projection arca 110 to which the body part is directed, using the length R1. The electronic device 101 may identify the plurality of visual objects 530 in the first portion 520. The electronic device 101 may change the plurality of visual objects 530 based on the length R1 based on identifying the plurality of visual objects 530. An example of changing the plurality of visual objects 530 will be described later in FIGS. 5B to 5C.

Referring to FIG. 5B, the electronic device 101 according to an embodiment may select an arca 510 based on the body part of the user. The electronic device 101 may identify the plurality of visual objects 530 (e.g., a visual object 530-1 to a visual object 530-5) in the area 510. The electronic device 101 may change the plurality of visual objects 530 included in the area 510 based on identifying the plurality of visual objects 530 in the area 510. For example, the electronic device 101 may change the first portion 520 in a projection area. For example, the electronic device 101 may display a second portion 560 in which the plurality of visual objects 530 included in the first portion 520 are changed. For example, the electronic device 101 may space the plurality of visual objects 530 in the second portion 560 by a length obtained based on the first distance and the second distance. For example, the electronic device 101 may display the first visual object 530-1 and the second visual object 530-2 to be spaced apart from each other by a length 550. For example, the length 550 may be represented as a sum of a first length 550-1 and a second length 550-2. However, the length 550 is not limited to the example described above. The electronic device 101 according to an embodiment may represent the plurality of visual objects 530 in the second portion 560 based on the length 550 in a state of maintaining an arrangement of the plurality of visual objects 530.

Referring to FIG. 5C, the electronic device 101 according to an embodiment may identify the first distance between the projection area and the user, and the second distance between the user and the electronic device 101. The electronic device 101 may identify the length R1 associated with the first distance and the second distance based on identifying the body part of the user. The length R1 may be referred to as the length R1 of FIGS. 3 to 4. The electronic device 101 may identify the body part (e.g., a fingertip) of the user toward the projection area. For example, the electronic device 101 may identify the area 510 based on the body part of the user. For example, the electronic device 101 may select the area 510 using the length R1 associated with the first distance and the second distance. For example, the area 510 may be an area including the plurality of visual objects 530 in the first portion 520 of the projection area. The electronic device 101 may identify the plurality of visual objects 530 in the area 510. The electronic device 101 may change the plurality of visual objects 530 based on identifying the plurality of visual objects 530 in the area 510. For example, the electronic device 101 may enlarge each of the plurality of visual objects 530 based on identifying the plurality of visual objects 530 in the area 510. For example, the electronic device 101 may display a plurality of enlarged visual objects 570-1, 570-2, 570-3, 570-4, and 570-5 in the second portion 560 matching the first portion 520. The electronic device 101 may display the plurality of enlarged visual objects 570-1, 570-2, 570-3, 570-4, and 570-5. In a case that the plurality of enlarged visual objects 570-1, 570-2, 570-3, 570-4, and 570-5 overlap, the electronic device 101 may move the plurality of enlarged visual objects 570-1, 570-2, 570-3, 570-4, and 570-5. For example, the electronic device 101 may dispose the overlapping plurality of visual objects 570-1, 570-2, 570-3, 570-4, and 570-5 to be spaced apart from each other by a reference distance by moving the plurality of enlarged visual objects 570-1, 570-2, 570-3, 570-4, and 570-5.

As described above, the electronic device 101 according to an embodiment may identify the first distance between the projection area 110 and the user 130, and the second distance between the user 130 and the electronic device 101 using the first sensor while displaying a screen including the plurality of visual objects 530. The electronic device 101 may identify the body part of the user 130 toward the projection area 110 using the second sensor different from the first sensor. Based on identifying the body part of the user 130 toward the projection area 110, the electronic device 101 may select the area 510 of the projection area 110 to which the body part is directed, using the length associated with the first distance and the second distance. The electronic device 101 may identify the plurality of visual objects 530 in the selected area 510. The electronic device 101 may change the plurality of visual objects 530 using the length based on identifying the plurality of visual objects 530 in the area 510. For example, the electronic device 101 may dispose the plurality of visual objects 530 to be spaced apart from each other by the length. For example, the electronic device 101 may enlarge and display the plurality of visual objects 530. The electronic device 101 may help easily selecting one of the plurality of visual objects 530 by the user of the electronic device 101 by providing a user interface in which the plurality of visual objects are disposed to be spaced apart from each other or are enlarged.

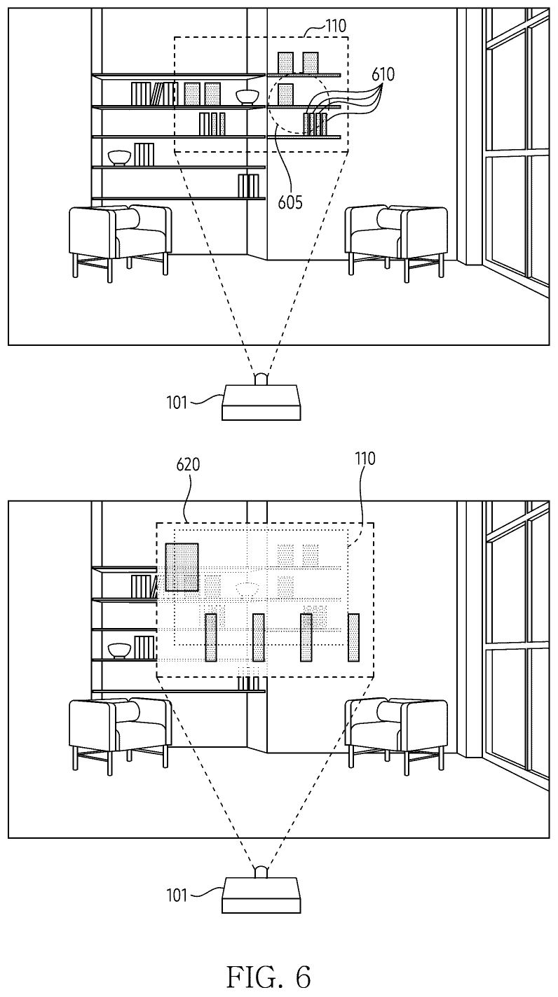

FIG. 6 illustrates an example of an electronic device that adjusts a size of a screen, according to an embodiment. An electronic device 101 of FIG. 6 may be an example of the electronic device 101 of FIGS. 1A, 1B, 2, 3, 4, 5A, 5B, and/or 5C. Operations of FIG. 6 may be performed by the processor 210 of FIG. 2.

Referring to FIG. 6, the electronic device 101 according to an embodiment may display a first screen including a plurality of visual objects in a projection area 110. The electronic device 101 may identify a first distance between the projection area 110 and a user (e.g., the user 305 of FIG. 3) using a first sensor (e.g., a depth sensor) while displaying the first screen including the plurality of visual objects. The electronic device 101 may identify a second distance between the user and the electronic device 101 using the first sensor while displaying the first screen. The electronic device 101 may obtain a length (e.g., the length R1 of FIG. 3) based on the first distance and the second distance. The electronic device 101 may identify a body part (e.g., a finger of the user) of the user toward the projection area 110 using a second sensor (e.g., an image sensor) different from the first sensor. Based on identifying the body part of the user toward the projection arca, the electronic device 101 may identify an area 605 of the projection area 110 to which the body part is directed, using the length. For example, the area 605 may be formed based on a point pointed by the user. The electronic device 101 may identify a plurality of visual objects 610 in the arca 605. The electronic device 101 may change the plurality of visual objects 610 based on the length based on identifying the plurality of visual objects 610 in the area 605 formed by selection of the user. The electronic device 101 may obtain a second screen 620 in which the plurality of visual objects 610 are changed.

The electronic device 101 according to an embodiment may identify a first size of the projection area 110 and/or a second size of the second screen 620. The electronic device 101 may compare the first size with the second size. The electronic device 101 may identify the second size of the second screen 620 having a size larger than the first size of the projection arca 110. The electronic device 101 may change the second size of the second screen 620 based on identifying the second size larger than the first size. For example, the second size larger than the first size may be a size exceeding the first size. For example, the electronic device 101 may reduce the second screen 620 having the second size based on identifying the second size of the second screen 620 larger than the first size of the projection area 110. For example, the electronic device 101 may reduce the second screen 620 of the second size to the first size.

The electronic device 101 according to an embodiment may reduce the second screen 620 having the second size to the first size. When reducing the second screen 620 of the second size, the electronic device 101 may change the plurality of visual objects 610 represented in the second screen 620. For example, the electronic device 101 may adjust a size of the plurality of visual objects 610 represented in the second screen 620. For example, the electronic device 101 may represent the size of the plurality of visual objects 610 represented as a third size in the second screen 620 as a fourth size smaller than the third size. For example, the electronic device 101 may change a disposition of the plurality of visual objects 610. For example, the electronic device 101 may reduce an interval between each of the plurality of visual objects 610 by a reference length in a state of maintaining an arrangement of the plurality of visual objects 610. The reference length may be larger than an interval between the plurality of visual objects 610 displayed in the first screen and smaller than an interval between the plurality of visual objects 610 in the second screen 620.

As described above, the electronic device 101 according to an embodiment may identify the plurality of visual objects 610 in the area 605 selected in the projection arca 110. The electronic device 101 may obtain the second screen 620 including the plurality of visual objects 610 based on identifying the plurality of visual objects 610 in the area 605. The electronic device 101 may identify a size of the projection area 110 and the second screen 620. The electronic device 101 may identify the second screen 620 having the second size larger than the first size of the projection area 110. The electronic device 101 may change the second size of the second screen 620 to the first size based on identifying the second screen 620 of the second size larger than the first size. The electronic device 101 may provide the second screen 620 in the projection arca 110 having a limited size by changing the second size of the second screen 620 based on identifying the second size of the second screen 620 larger than the first size of the projection area 110. The electronic device 101 may enhance user convenience of the electronic device 101 by providing the second screen 620.

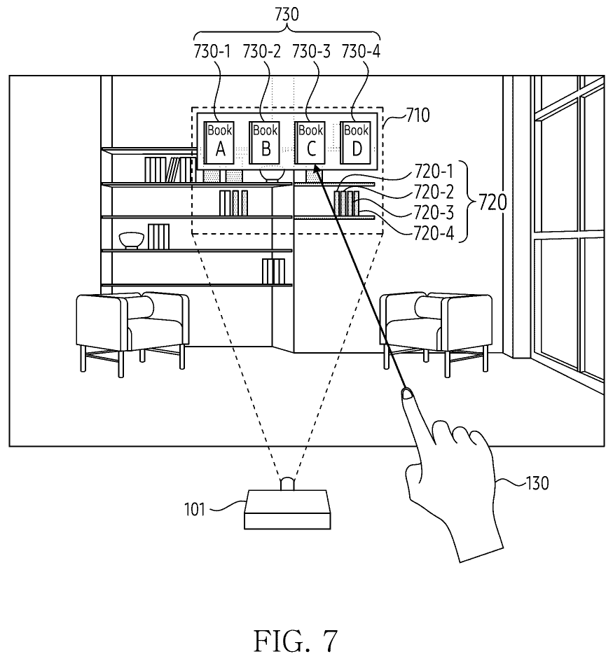

FIG. 7 illustrates an example of an electronic device that changes visual objects, according to an embodiment. An electronic device 101 of FIG. 7 may include the electronic device 101 of FIGS. 1A, 1B, 2, 3, 4, 5A, 5B, 5C, and/or 6. Operations of FIG. 7 may be performed by the processor 210 of FIG. 2.

Referring to FIG. 7, the electronic device 101 according to an embodiment may display a plurality of visual objects 720 in the projection arca 710. The electronic device 101 may identify a body part of a user 130 toward the projection arca 710. The electronic device 101 may identify a second state different from a first state identifying an input indicating selection of the plurality of visual objects 720 while identifying the body part of the user 130 toward the projection arca 710. For example, the second state may include a state in which an input for one of the plurality of visual objects 720 is not identified by the user 130. The electronic device 101 may display information associated with the visual objects 720 displayed in the projection area 710 based on the second state being identified for a preset duration. For example, the electronic device 101 may display the information associated with the plurality of visual objects 720 in the second state based on at least a portion of the projection area 710. The electronic device 101 may display visual objects 730 representing the information associated with the visual objects 720 and corresponding to each of the plurality of visual objects 720 on the at least a portion of the projection area 710.

The electronic device 101 according to an embodiment may display the visual objects 730 representing information of the plurality of visual objects 720 and corresponding to each of the plurality of visual objects 720 in the second state. For example, the information of the plurality of visual objects 720 may include a title for indicating the plurality of visual objects 720. For example, the information of the plurality of visual objects 720 may be loaded from memory. For example, the information of the plurality of visual objects 720 may be obtained from an external electronic device connected through communication circuitry. For example, the electronic device 101 may display the visual objects 730 representing the information based on receiving the information associated with each of the visual objects 720 from the external electronic device. However, it is not limited thereto. For example, the electronic device 101 may display a first visual object 720-1, a second visual object 720-2, a third visual object 720-3, and/or a fourth visual object 720-4. The electronic device 101 may identify the second state while displaying the first visual object 720-1 to the fourth visual object 720-4. The electronic device 101 may display the visual objects 730 representing information corresponding to each of the first visual object 720-1 to the fourth visual object 720-4 in the second state for the preset duration. For example, the electronic device 101 may display a fifth visual object 730-1 corresponding to the first visual object 720-1. For example, the electronic device 101 may display a sixth visual object 730-2 corresponding to the second visual object 720-2. For example, the electronic device 101 may display a seventh visual object 730-3 corresponding to the third visual object 720-3. For example, the electronic device 101 may display an eighth visual object 730-4 corresponding to the fourth visual object 720-4. The electronic device 101 may display the visual objects 730 in a preset arca in the projection arca 710.

As described above, the electronic device 101 according to an embodiment may identify the second state different from the first state of selecting one of the plurality of visual objects 720. The electronic device 101 may identify that the second state is maintained for the preset duration. The electronic device 101 may display the information associated with the plurality of visual objects 720 based on the second state being maintained for the preset duration. For example, the electronic device 101 may display the visual objects 730 representing the information associated with the plurality of visual objects 720. The electronic device 101 may provide a user of the electronic device 101 with a guide for selecting one of the plurality of visual objects 720 by displaying the visual objects 730.

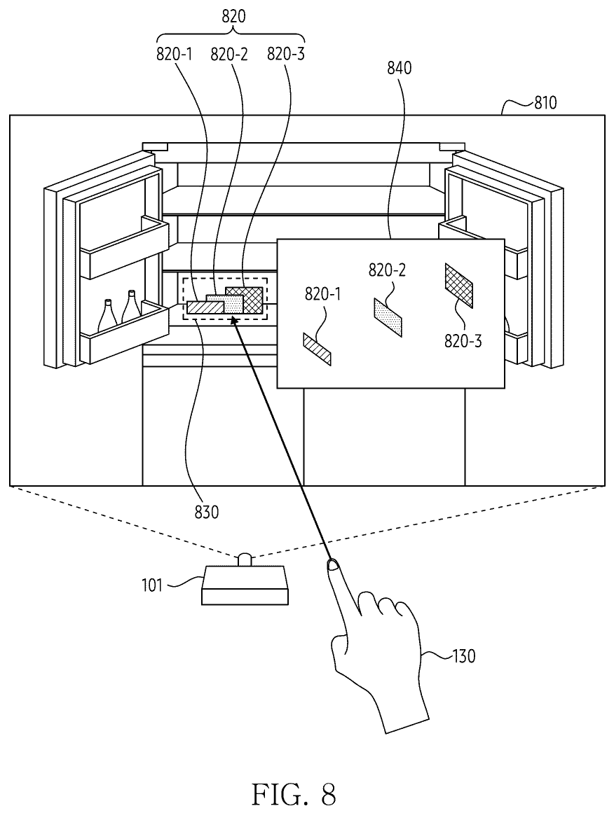

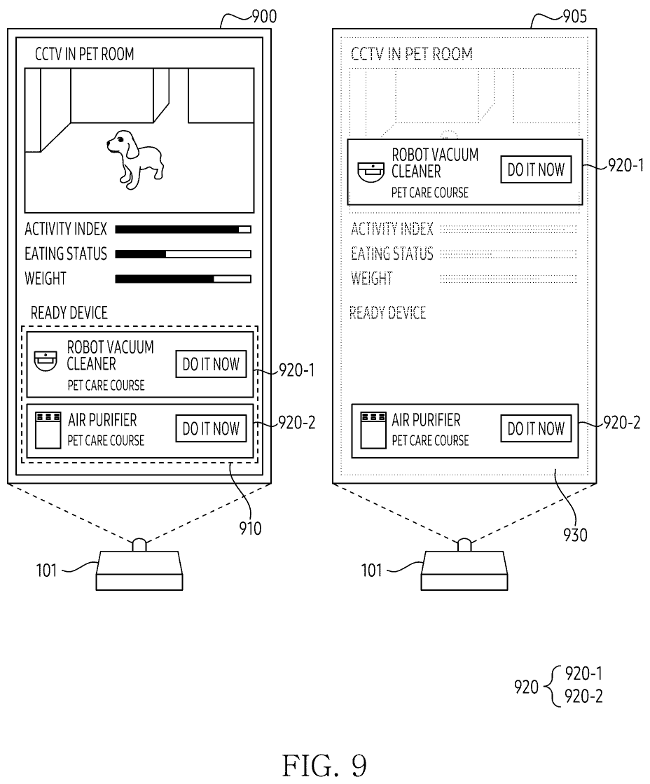

FIG. 8 illustrates an example of an electronic device that changes visual objects, according to an embodiment. FIG. 9 illustrates an example of an electronic device that changes visual objects, according to an embodiment. An electronic device 101 of FIGS. 8 to 9 may include the electronic device 101 of FIGS. 1A, 1B, 2, 3, 4, 5A, 5B, 5C, 6, and/or 7. Operations of FIGS. 8 to 9 may be performed by the processor 210 of FIG. 2.

Referring to FIG. 8, the electronic device 101 according to an embodiment may provide virtual reality through a projection area 810. For example, the electronic device 101 may display a plurality of visual objects 820 while providing the virtual reality through the projection area 810. The electronic device 101 may identify a body part of a user 130 toward the projection area 810 while displaying the plurality of visual objects 820. For example, the electronic device 101 may identify the body part of the user 130 toward the plurality of visual objects 820. A first visual object 820-1 to a third visual object 820-3 may be the visual object selectable by the user 130. The electronic device 101 may change the plurality of visual objects 820 based on identifying the body part of the user 130 toward overlapping plurality of visual objects 820. For example, the electronic device 101 may display the overlapping plurality of visual objects 820 in a second arca 840 different from a first area 830 in which the overlapping plurality of visual objects 820 are represented. For example, the electronic device 101 may change a position of the overlapping plurality of visual objects 820. The electronic device 101 may display each of the overlapping plurality of visual objects 820 to be spaced apart from each other. For example, the electronic device 101 may display the first visual object 820-1, a second visual object 820-2, and/or the third visual object 820-3.

Referring to FIG. 9, in a first example 900, the electronic device 101 according to an embodiment may display visual objects 920 for executing a function in a projection area. The electronic device 101 may identify an input of a user for selecting one of the visual objects 920 in the projection arca. For example, the electronic device 101 may identify the input of the user while displaying a first visual object 920-1 and a second visual object 920-2. For example, the first visual object 920-1 and the second visual object 920-2 may be visual objects spaced apart from each other by less than a preset distance. The electronic device 101 may identify the input of the user in a first area 910 including the first visual object 920-1 and the second visual object 920-2. For example, the input of the user may be identified based on a direction to which the body part (e.g., a finger of the user) of the user is directed. The electronic device 101 may change a disposition of the visual objects 920 based on identifying the input of the user in the first area 910. Hereinafter, an example in which the disposition of the visual objects 920 is changed will be described based on a second example 905.

In the second example 905, the electronic device 101 according to an embodiment may change the disposition of the first visual object 920-1 and the second visual object 920-2. For example, the electronic device 101 may dispose the first visual object 920-1 and the second visual object 920-2, to be spaced apart from each other by a reference length. The electronic device 101 may adjust an alpha value for an area 930 other than the first visual object 920-1 and the second visual object 920-2 while disposing the first visual object 920-1 and the second visual object 920-2 to be spaced apart from each other. For example, the electronic device 101 may increase the alpha value of the area 930 while changing the disposition of the first visual object 920-1 and the second visual object 920-2. The electronic device 101 may decrease transparency of the area 930 based on the increase in the alpha value. The electronic device 101 according to an embodiment may adjust lightness and/or brightness of the area 930 while changing the disposition of the first visual object 920-1 and the second visual object 920-2. For example, the electronic device 101 may increase the lightness of the area 930 while disposing the first visual object 920-1 and the second visual object 920-2 to be spaced apart from each other by the reference length. For example, the electronic device 101 may decrease the brightness of the area 930 while disposing the first visual object 920-1 and the second visual object 920-2 to be spaced apart from each other by the reference length. By adjusting the lightness and/or the brightness, the electronic device 101 may highlight and display the first visual object 920-1 and the second visual object 920-2.

As described above, the electronic device 101 according to an embodiment may represent the virtual reality in the projection area. The electronic device 101 may identify the visual objects in the virtual reality. The electronic device 101 may identify the overlapping visual objects. The electronic device 101 may identify visual objects spaced apart from each other by less than the reference distance. The electronic device 101 may change a position of the visual objects based on identifying the visual objects. The electronic device 101 may help easily selecting one of the visual objects for the user of the electronic device 101 by changing the position of the visual objects.

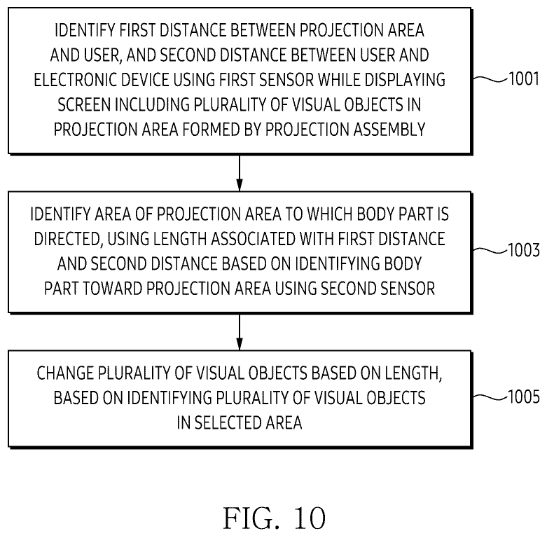

FIG. 10 illustrates an example of a flowchart of an operation of an electronic device according to an embodiment. An electronic device of FIG. 10 may include the electronic device 101 of FIGS. 1A, 1B, 2, 3, 4, 5A, 5B, 5C, 6, 7, 8, and/or 9. Operations of FIG. 10 may be performed by the processor 210 of FIG. 2.

Referring to FIG. 10, in operation 1001, the electronic device according to an embodiment may display a first screen including a plurality of visual objects in a projection arca formed by a projection assembly. The electronic device may identify a first distance between the projection arca and a user, and a second distance between the user and the electronic device using a first sensor. The electronic device may identify the first distance between the projection arca and the user, and the second distance between the user and the electronic device using the first sensor while displaying the first screen including the plurality of visual objects in the projection arca formed by the projection assembly.

In operation 1003, the electronic device according to an embodiment may identify a body part toward the projection area using a second sensor. The electronic device may select an area of the projection area to which the body part is directed, using a length associated with the first distance and the second distance. The electronic device may select the area of the projection arca to which the body part is directed, using the length associated with the first distance and the second distance based on identifying the body part toward the projection area using the second sensor.

In operation 1005, the electronic device according to an embodiment may identify the plurality of visual objects in the selected area. The electronic device may change the plurality of visual objects. The electronic device may obtain a length based on the first distance and the second distance. The electronic device may change the plurality of visual objects based on the length, based on identifying the plurality of visual objects in the selected area.

As described above, the electronic device according to an embodiment may obtain a length by performing an algorithm with respect to the first distance and the second distance. The electronic device may select an area to which the body part of the user is directed based on the length. The electronic device may identify the plurality of visual objects in the area. The electronic device may change the plurality of visual objects based on identifying the plurality of visual objects in the area. The electronic device may provide the user of the electronic device with a user interface easily selecting one of the plurality of visual objects by changing the plurality of visual objects based on the length.

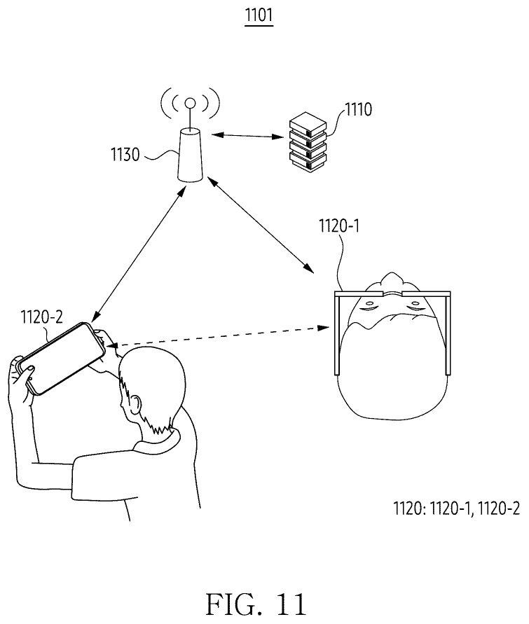

FIG. 11 illustrates an exemplary state in which electronic devices 1110 and 1120 capable of performing the operations described in the present document are connected through a network.

Referring to FIG. 11, the electronic device 1110 may include a server for a service provided to a user 1130 of the electronic device 1120. The server may include a cloud server and/or a distributed server. The service provided through the electronic device 1110 may include a service (e.g., a metaverse service) based on interconnectivity between a real object and a virtual object. For example, the service may be referred to as a universe service, an immersive service, or a virtual platform.

The electronic device 1120 of FIG. 11 may be referred to as a terminal and/or user equipment (UE). Exemplary form factors (e.g., a head-mounted display (HMD) 1120-1 and/or a smartphone 1120-2) of the electronic device 1120 are illustrated in FIG. 11. The form factors of FIG. 11 are merely exemplary. FIG. 11 illustrates the HMD 1120-1 having a shape of glasses that is wearable on a head, but the electronic device 1120 may have a shape that is wearable on a body part (e.g., a wrist) different from the head. Such as the HMD 1120-1, the electronic device 1120 that is wearable by the user may be referred to as a wearable device.

Through the electronic device 1110 and/or the electronic device 1120, the service for supporting interaction between physically separated users may be provided. Referring to FIG. 11, users 1130-1 and 1130-2 included in an environment 1140 may be included in physically separated environments 1140-1 and 1140-2. For example, the environment 1140-1 and the environment 1140-2 being physically separated may indicate that the user 1130-1 is unable to communicate with the user 1130-2 without use of the electronic device 1120-1 and the electronic device 1120-2. For example, the environment 1140-1 and the environment 1140-2 being physically separated may indicate that the user 1130-1 may not recognize a state of the environment 1140-2 without use of the electronic device 1120-1 and the electronic device 1120-2, and that the user 1130-2 may not recognize a state of the environment 1140-1 without use of the electronic device 1120-1 and the electronic device 1120-2.

Based on a service provided through the HMD 1120-1 and the smartphone 1120-2 corresponding to each of the users 1130-1 and 1130-2, the physical separation between the users 1130-1 and 1130-2 may be compensated. For example, the service may support an exchange of information that compensates for the physical separation between the users 1130-1 and 1130-2 based on communication links illustrated in FIG. 11. The information may include visualized content such as text, an image, and/or a video, auditoryized content such as a speech and/or music, tactile-based content such as a vibration, or a combination thereof. The information may include data detected by a sensor (e.g., a camera) of the electronic device 1120. The information may include data for outputting at least one of the contents exchanged between the users 1130-1 and 1130-2 based on a virtual space. The users 1130-1 and 1130-2 separated in a real world may interact based on the information exchanged through the HMD 1120-1 and the smartphone 1120-2.

The information may be exchanged between the electronic devices 1110 and 1120 in various methods.

For example, the information may be transmitted from the HMD 1120-1 to the smartphone 1120-2 through a direct connection between the HMD 1120-1 and the smartphone 1120-2.

For example, the information may be exchanged between the electronic devices 1110 and 1120 through a network formed by at least one intermediate node 1180 (e.g., an access point (AP), and/or a base station). For example, the information generated by the smartphone 1120-2 may be provided to the HMD 1120-1 through the network. For example, the information generated by the HMD 1120-1 may be transmitted directly to the smartphone 1120-2 or transmitted to the smartphone 1120-2 through the at least one AP 1180.

Through the electronic devices 1110 and 1120, based on the service, a real space and a virtual space 1150 may be at least partially fused. The service may support the exchange of information between physically separated users 1130-1 and 1130-2 based on the virtual space 1150. For example, the electronic device 1120 may perform an operation based on a coupling of the real world in which the user 1130 is included and the virtual space 1150, based on the service. The operation may include an operation of outputting multimedia content based on a coupling of information in the real world, which is detected by the electronic device 1120, and information included in the virtual space 1150 formed by the electronic device 1110, to the user 1130.

A virtual object 1160 is illustrated as an example of multimedia content displayed to the user 1130 who has accessed the virtual space 1150 based on the electronic device 1120. The multimedia content may include an avatar 1160-1 based on account information of the user 1130-1 logged into the virtual space 1150 based on the HMD 1120-1, and/or an avatar 1160-2 corresponding to the user 1130-2 logged into the virtual space 1150 based on the smartphone 1120-2. The user 1130-2 may control the avatar 1160-2 corresponding to the user 1130-2 in the virtual space 1150 using the smartphone 1120-2. Based on the virtual object 1160 including the avatars 1160-1 and 1160-2, an interaction between the physically separated users 1130-1 and 1130-2 may be performed in the virtual space 1150. For example, the user 1130-1 may add multimedia content 1170 exchanged between the avatars 1160-1 and 1160-2 into the virtual space 1150 using the HMD 1120-1. Based on movement (or a transaction) of the multimedia content 1170 in the virtual space 1150, the interaction between the users 1130-1 and 1130-2 corresponding to the avatars 1160-1 and 1160-2 may be caused in the virtual space 1150.

Information indicating at least a portion of the virtual space 1150 of FIG. 11 may be shared between the electronic devices 1110 and 1120. The HMD 1120-1 may obtain information for visualizing a portion of the virtual space 1150 adjacent to the avatar 1160-1. The HMD 1120-1 may visualize the obtained information based on a virtual reality (VR), an augmented reality (AR), and/or a mixed reality (MR). The smartphone 1120-2 may obtain other information for visualizing another portion of the virtual space 1150 adjacent to the avatar 1160-2. The smartphone 1120-2 may provide the user 1130-2 with a user experience based on the other portion of the virtual space 1150 by controlling a display and/or a speaker based on the other information.

A method for accurately selecting a plurality of visual objects may be required. As described above, an electronic device 101 according to an embodiment may include a first sensor 250, a second sensor 250, a projection assembly 220, and a processor 210. The processor 210 may identify, while displaying a screen including a plurality of visual objects 530 in a projection arca 110 formed by the projection assembly 220, using the first sensor 250, a first distance D2 between the projection area 110 and a user, and a second distance D1 between the user and the electronic device 101. The processor 210 may select, based on identifying a body part toward the projection area 110 using the second sensor 250, an area of the projection area 110 to which the body part is directed, using a length R1 associated with the first distance D2 and the second distance D1. The processor 210 may change, based on identifying the plurality of visual objects 530 in the selected area, the plurality of visual objects 530 based on the length R1.

The processor 210 according to an embodiment may enlarge the plurality of visual objects 530 identified in the area to a size corresponding to the length R1.

The processor 210 according to an embodiment may arrange the plurality of visual objects 530 identified in the area spaced apart from each other by the length R1.

The processor 210 according to an embodiment may display information associated with the changed plurality of visual objects 530.

The electronic device 101 according to an embodiment may include communication circuitry 240. The processor 210 may receive the information from an external electronic device 101 through the communication circuitry 240.

The electronic device 101 according to an embodiment may include memory. The processor 210 may display the information associated with the plurality of visual objects 530 that is stored in the memory.

The processor 210 according to an embodiment may display the second screen, that is different from a first screen which is the screen, in which a size of the area is changed.

The processor 210 according to an embodiment may reduce, based on obtaining the second screen of a second size larger than a first size of the projection area 110, the second size of the second screen to the first size.

As described above, a method of an electronic device 101 according to an embodiment may include, while displaying a first screen including a plurality of visual objects 530 in a projection area 110 formed by a projection assembly 220, identifying, using a first sensor 250, a first distance D2 between the projection area 110 and a user, and a second distance D1 between the user and the electronic device 101. The method may include, based on identifying a body part toward the projection area 110 using a second sensor 250, selecting an area of the projection area 110 to which the body part is directed, using a length R1 associated with the first distance D2 and the second distance D1. The method may include, based on identifying the plurality of visual objects 530 in the selected area, changing the plurality of visual objects 530 based on the length R1.

The method according to an embodiment may include enlarging the plurality of visual objects 530 identified in the area to a size corresponding to the length R1.

The method according to an embodiment may include arranging the plurality of visual objects 530 identified in the area spaced apart from each other by the length R1.

The method according to an embodiment may include displaying information associated with the changed plurality of visual objects 530.

The method according to an embodiment may include receiving the information from an external electronic device 101 through communication circuitry 240.

The method according to an embodiment may include displaying the information associated with the plurality of visual objects 530 that is stored in the memory.

The method according to an embodiment may include displaying the second screen, in which the area including the identified plurality of visual objects 530 is changed.

The method according to an embodiment may include, based on obtaining the second screen of a second size larger than a first size of the projection area 110, reducing the second size of the second screen to the first size.

As described above, in a non-transitory computer readable storage medium storing one or more programs according to an embodiment, the one or more programs, when executed by a processor 210 of an electronic device 101, may cause the processor 210 of the electronic device 101 to, while displaying a first screen including a plurality of visual objects 530 in a projection arca 110 formed by a projection assembly 220, identify, using a first sensor 250, a first distance D2 between the projection area 110 and a user, and a second distance D1 between the user and the electronic device 101. The one or more programs, when executed by the processor of the electronic device, may cause the processor 210 of the electronic device 101 to, based on identifying a body part toward the projection area 110 using a second sensor 250, select an area of the projection arca 110 to which the body part is directed, using a length R1 associated with the first distance D2 and the second distance D1. The one or more programs, when executed by the processor of the electronic device, may cause the processor 210 of the electronic device 101 to, based on identifying the plurality of visual objects 530 in the selected area, change the plurality of visual objects 530 based on the length R1. “Based on” as used herein covers based at least on.

The one or more programs according to an embodiment may cause the processor 210 of the electronic device 101 to, when executed by the processor 210 of the electronic device 101, enlarge the plurality of visual objects 530 identified in the area to a size corresponding to the length R1.

The one or more programs according to an embodiment may cause the processor 210 of the electronic device 101 to, when executed by the processor 210 of the electronic device 101, arrange the plurality of visual objects 530 identified in the area spaced apart from each other by the length R1.

The one or more programs according to an embodiment may cause the processor 210 of the electronic device 101 to, when executed by the processor 210 of the electronic device 101, display information associated with the changed plurality of visual objects 530.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first clement) is referred to, with or without the term “operatively” or “communicatively”, as “coupled with,” or “connected with” another element (e.g., a second clement), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device 101). For example, a processor (e.g., the processor 210) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

What is claimed is:

1. An electronic device comprising:
a first sensor;
a second sensor;
a projection assembly comprising a projector;
at least one processor including processing circuitry; and
memory storing instructions,
wherein the instructions, when executed individually and/or collectively by the at least one processor, cause the electronic device to:
while displaying a screen including a plurality of visual objects in a projection area formed via the projection assembly, identify, based at least one information from the first sensor, a first distance between the projection area and a user, and a second distance between the user and the electronic device;
based on identifying a body part toward the projection area based on at least the second sensor, select an area of the projection area to which the body part is directed, based on a length associated with the first distance and the second distance; and
based on identifying the plurality of visual objects in the selected area, change the plurality of visual objects based on the length.

2. The electronic device of claim 1, wherein the instructions, when executed individually and/or collectively by at least one processor, cause the electronic device to:
enlarge the plurality of visual objects identified in the area to a size corresponding to the length.

3. The electronic device of claim 1, wherein the instructions, when executed individually and/or collectively by at least one processor, cause the electronic device to:
arrange the plurality of visual objects identified in the area spaced apart from each other by the length.

4. The electronic device of claim 1, wherein the instructions, when executed individually and/or collectively by at least one processor, cause the electronic device to:
display information associated with the changed plurality of visual objects.

5. The electronic device of claim 4, further comprising:
communication circuitry,
wherein the instructions, when executed individually and/or collectively by at least one processor, cause the electronic device to:
receive the information from an external electronic device through the communication circuitry.

6. The electronic device of claim 4, further comprising:
memory,
wherein the instructions, when executed individually and/or collectively by at least one processor, cause the electronic device to:
display the information associated with the plurality of visual objects that is stored in the memory.

7. The electronic device of claim 1, wherein the instructions, when executed individually and/or collectively by at least one processor, cause the electronic device to:
display the second screen, that is different from a first screen which is the screen, in which a size of the area is changed.

8. The electronic device of claim 7, wherein the instructions, when executed individually and/or collectively by at least one processor, cause the electronic device to:
based on obtaining the second screen of a second size larger than a first size of the projection area, reduce the second size of the second screen to the first size.

9. A method of an electronic device, the method comprising:
while displaying a first screen including a plurality of visual objects in a projection area formed via a projection assembly, identifying, using a first sensor, a first distance between the projection area and a user, and a second distance between the user and the electronic device;
based on identifying a body part toward the projection area using a second sensor, selecting an area of the projection area to which the body part is directed, using a length associated with the first distance and the second distance; and
based on identifying the plurality of visual objects in the selected area, changing the plurality of visual objects based on the length.

10. The method of claim 9, comprising:
enlarging the plurality of visual objects identified in the area to a size corresponding to the length.

11. The method of claim 9, comprising:
arranging the plurality of visual objects identified in the area spaced apart from each other by the length.

12. The method of claim 9, comprising:
displaying information associated with the changed plurality of visual objects.

13. The method of claim 12, comprising:
receiving the information from an external electronic device through communication circuitry.

14. The method of claim 12, comprising:
displaying the information associated with the plurality of visual objects that is stored in the memory.

15. The method of claim 9, comprising:
displaying the second screen, in which the area including the identified plurality of visual objects is changed.

16. The method of claim 15, comprising:
based on obtaining the second screen of a second size larger than a first size of the projection area, reducing the second size of the second screen to the first size.

17. A non-transitory computer readable storage medium storing one or more programs, wherein the one or more programs, when executed by a processor of an electronic device, cause the electronic device to operations comprising:
while displaying a first screen including a plurality of visual objects in a projection area formed by a projection assembly, identify, using a first sensor, a first distance between the projection area and a user, and a second distance between the user and the electronic device;
based on identifying a body part toward the projection area using a second sensor, select an area of the projection area to which the body part is directed, using a length associated with the first distance and the second distance; and
based on identifying the plurality of visual objects in the selected area, change the plurality of visual objects based on the length.

18. The non-transitory computer readable storage medium of claim 17, wherein the one or more programs, when executed individually and/or collectively by at least one processor of the electronic device, cause the processor of the electronic device to:
enlarge the plurality of visual objects identified in the area to a size corresponding to the length.

19. The non-transitory computer readable storage medium of claim 17, wherein the one or more programs, when executed individually and/or collectively by at least one processor of the electronic device, cause the processor of the electronic device to:
arrange the plurality of visual objects identified in the area spaced apart from each other by the length.

20. The non-transitory computer readable storage medium of claim 17, wherein the one or more programs, when executed individually and/or collectively by at least one processor of the electronic device, cause the processor of the electronic device to:
display information associated with the changed plurality of visual objects.
